(19) United States
(12) Patent Application Publication
(10) Pub. No.: US 2019/0378085 A1
(43) Pub. Date: Dec. 12, 2019

(54) Autonomous merchandise delivery system

(71) Applicant: Keith R. Sipes, Santa Barbara, CA (US)

(72) Inventor: Keith R. Sipes, Santa Barbara, CA (US)

(21) Appl. No.: 16/001,421

(22) Filed: Jun. 6, 2018

(51) Int. Cl. G06Q 10/08

(52) U.S. Cl. CPC G06Q 10/0833; G05D 1/021

(57) ABSTRACT

A method, system and apparatus for delivering a package from a first site to a second site includes predetermining a precise location at the second site to which the package is to be delivered; placing the package to be delivered into a vault equipped with an audible tamper alarm and a wireless communication system; placing the vault onto an autonomous driving vehicle (ADV); causing the ADV to drive the package to be delivered from the first site to the second site; delivering the vault to the precise location using a robotic movement device mounted to the ADV to transfer the vault from the ADV to the precise location; causing the ADV to depart the second site after transfer of the vault; and in response to reported acceptance of the package, causing an ADV to return to the second site to retrieve the vault.

### TECHNICAL FIELD

The present disclosure relates generally to a system and method for autonomous delivery of package vaults containing items to be delivered.

### BACKGROUND

In recent years the number of packages containing merchandise delivered to homes and businesses (customers) has increased dramatically. Much of this merchandise is ordered using on-line websites. Such on-line websites are in the process of largely replacing more traditional brick and mortar stores as a source for merchandise. At present most merchandise is placed in a package and delivered by a third-party delivery service to homes and businesses by human-piloted delivery vehicles (e.g., trucks and vans) to a predetermined delivery address and either handed to an occupant/customer or left at a designated place at or near the home or business. As a result, some of the merchandise left for pickup is stolen, lost, misdelivered or damaged in handling resulting in expensive “shrinkage”. It is also costly to hire, train, insure and equip human drivers to accomplish the task of delivering merchandise. Various autonomous systems have been proposed for delivering merchandise such as drone helicopters, autonomous driving vehicles, and the like. These approaches bring their own set of problems—primarily involving security of the package between the time of actual delivery to a customer site and actual receipt of the package by the customer as most customers are normally unavailable at the time of delivery. An improved, more efficient and secure system for delivering merchandise to customers would be desirable.

### OVERVIEW

The subject matter described herein generally relates to apparatus, systems, methods and associated computer instructions for accomplishing the delivery of items, such as packages containing merchandise, unpackaged merchandise and other items to customers in an autonomous but secure manner.

The foregoing overview is a summary and thus may contain simplifications, generalizations, and omissions of detail; consequently, those skilled in the art will appreciate that the overview is illustrative only and is not intended to be in any way limiting.

### BRIEF DESCRIPTION OF THE DRAWINGS

The accompanying drawings, which are incorporated into and constitute a part of this specification, illustrate one or more exemplary embodiments and, together with the description of the exemplary embodiments, serve to explain the principles and implementations of the invention.

In the drawings:

FIG. 1 is a system block diagram illustrating a computer system configured for implementing at least one of a method, a system and software in accordance with exemplary embodiments.

FIG. 2 is a system block diagram illustrating a portion of a data communications network coupling a user's computer device to a server device.

FIG. 3 is a system block diagram of an autonomous merchandise delivery system in accordance with an embodiment.

FIGS. 4A and 4B illustrate embodiments wherein an autonomous delivery vehicle with a robotic arm delivers a vault to a site.

FIG. 5 is a system block diagram illustrating a configuration of electronics provided with a package vault in accordance with an embodiment.

FIG. 6A is a schematic diagram of a closed package vault in accordance with an embodiment.

FIG. 6B is a schematic diagram of an open package vault in accordance with an embodiment.

### DESCRIPTION OF EXAMPLE EMBODIMENTS

Exemplary embodiments are described herein in the context of an autonomous merchandise delivery system. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the exemplary embodiments as illustrated in the accompanying drawings. The same reference indicators will be used to the extent possible throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming but would nevertheless be a routine undertaking of engineering for those of ordinary skill in the art having the benefit of this disclosure.

References herein to “one embodiment” or “an embodiment” or “one implementation” or “an implementation” means that a particular feature, structure, part, function or characteristic described in connection with an exemplary embodiment can be included in at least one exemplary embodiment. The appearances of phrases such as “in one embodiment” or “in one implementation” in different places within this specification are not necessarily all referring to the same embodiment or implementation, nor are separate and alternative embodiments necessarily mutually exclusive of other embodiments.

In accordance with this disclosure, the components, process steps, and/or data structures described herein may be implemented using various types of operating systems, computing platforms, computer programs, and/or general-purpose machines. In addition, those of ordinary skill in the art will recognize that devices of a less general-purpose nature, such as hardwired devices, field programmable gate arrays (FPGAs), application specific integrated circuits (ASICs), or the like, may also be used without departing from the scope and spirit of the inventive concepts disclosed herein.

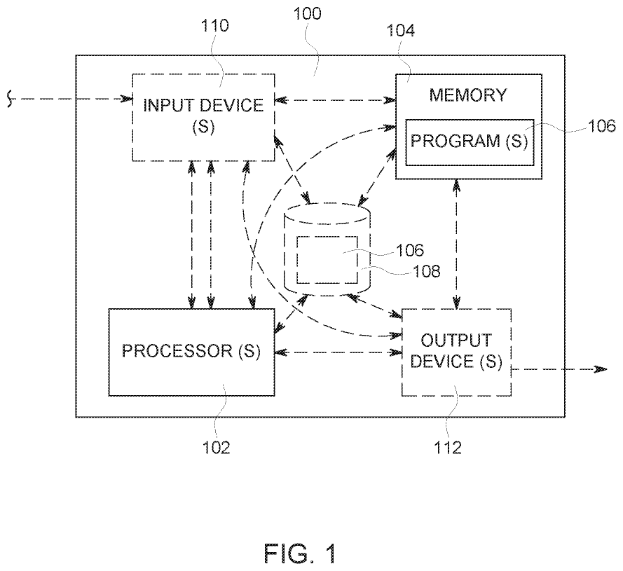

FIG. 1 is a system block diagram illustrating a computer system configured for implementing at least one of a method, a system and software in accordance with exemplary embodiments. FIG. 1 depicts a device or a computer system 100 comprising one or more processors 102 and a memory 104 storing one or more programs 106 for execution by the one or more processors 102.

In some embodiments, the device or computer system 100 can further comprise a non-transitory computer-readable storage medium 108 storing the one or more programs 106 for execution by the one or more processors 102 of the device or computer system 100.

In some embodiments, the device or computer system 100 can further comprise one or more input devices 110, which can be configured to send or receive information to or from any one or more of: an external device (not shown), a website (not shown), the one or more processors 102, the memory 104, the non-transitory computer-readable storage medium 108, and one or more output devices 112.

In some embodiments, the device or computer system 100 can further comprise one or more output devices 112, which can be configured to send or receive information to or from any one from the group consisting of: an external device (not shown in FIG. 1), the one or more processors 102, the memory 104, and the non-transitory computer-readable storage medium 108.

Each of the above identified steps, modules or programs corresponds to a set of instructions for performing a function described above. These modules and programs (i.e., sets of instructions) need not be implemented as separate software programs, procedures or modules, and thus various subsets of these modules may be combined or otherwise re-arranged in various embodiments. In some embodiments, memory may store a subset of the modules and data structures identified above. Furthermore, memory may store additional modules and data structures not described above.

The illustrated aspects of the disclosure may also be practiced in distributed computing environments where certain tasks are performed by remote processing devices that are linked through a data communications network. In a distributed computing environment, program modules can be located in both local and remote memory storage devices.

Moreover, it is to be appreciated that various components described herein can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What is described here includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems, circuits and modules are described herein with respect to interaction between several components or blocks. It can be appreciated that such systems, circuits and modules circuits and components or blocks can include those components or specified subcomponents, some of the specified components or sub-components, and/or additional components, and according to various permutations and combinations of the foregoing. Subcomponents can also be implemented as components communicatively coupled to other components rather than included within parent components. Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer-readable medium; or a combination thereof.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include tangible computer-readable storage media and/or communications media, in which these two terms are used herein differently from one another as follows. Tangible computer-readable storage media can be any available storage media that can be accessed by the computer, is typically of a non-transitory nature, and can include both volatile and nonvolatile media, removable and non-removable media. By way of example, and not limitation, tangible computer-readable storage media can be implemented in connection with any method or technology for storage of information such as computer-readable instructions, program modules, structured data, or unstructured data. Tangible computer-readable storage media can include, but are not limited to, RAM (random access memory), ROM (read-only memory), PROM (programmable read-only memory), EEPROM (electrically erasable programmable read-only memory), flash memory, jump drives, USB (universal serial bus) drives (and the like) or other memory technology, compact disk (CD and CD-ROM), digital versatile disk (DVD and DVD-ROM), paper card, paper tape or other information storage media, magnetic cassettes, magnetic tape, magnetic disk storage or other magnetic storage devices, or other tangible and/or non-transitory media which can be used to store desired information. Tangible computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be appreciated that the methodologies disclosed in this specification are capable of being stored on an article of manufacture to facilitate transporting and transferring such methodologies to computing devices. The term article of manufacture, as used herein, is intended to encompass a computer program accessible from any computer-readable device or storage media.

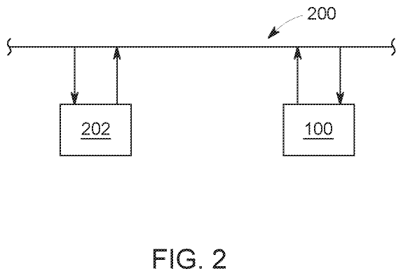

FIG. 2 is a system block diagram illustrating a portion of a data communications network coupling a computer system to a user's computer. This is a typical scenario wherein a computer system 100 such as a web server provides computer functionality to a user's computer 202 over a data communications network 200 such as a local area network (LAN) or the Internet. The user's computer 202 may be coupled via wires and/or wirelessly to the data communications network 200 so that the user may access the computer system 100. The user's computer 202 may also be used via a computer network such as a Local Area Network (LAN) or the Internet to access websites in conjunction with the function of the satellite communication system 300 described in more detail below.

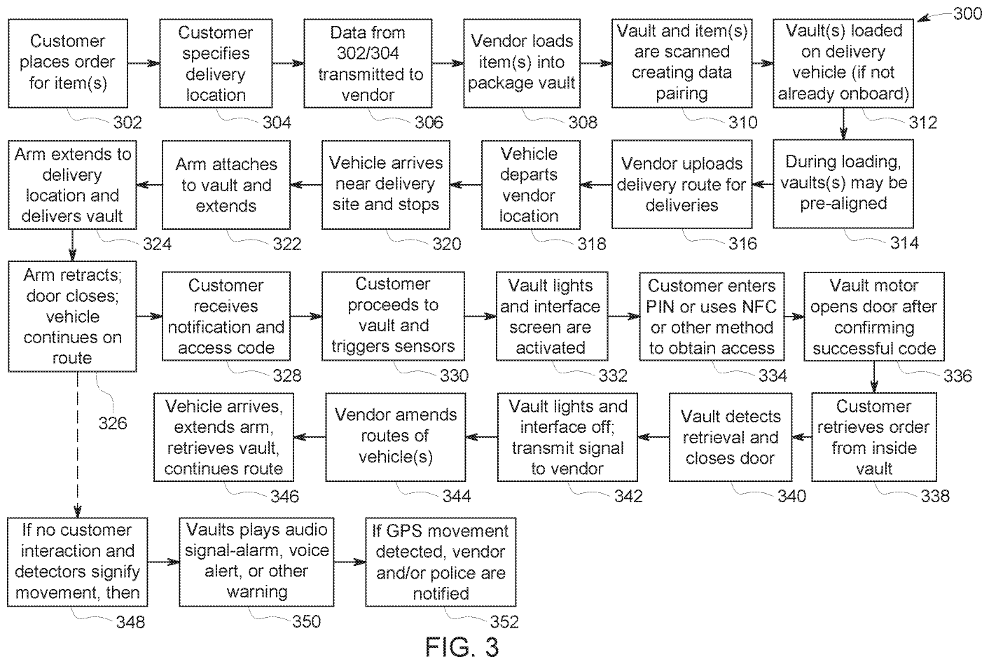

FIG. 3 is a process flow diagram of an autonomous merchandise delivery system 300 in accordance with an embodiment. In accordance with the embodiment illustrated in FIG. 3, at block 302 a customer contacts a computer system such as a web server associated with a vendor with the customer's computing (such as, e.g., a personal computer, a pad device or a smart phone) or uses other means such as a phone or in-person communication whereby the vendor interfaces with the web server and orders merchandise for delivery to a customer site (sometimes referred to herein as a “second site”). The merchandise may be packaged or unpackaged but most commonly will be packaged and labelled for delivery to the customer. The merchandise may include rental items which might later be returned. It may include samples, raw materials, food (prepared and/or unprepared), pharmaceutical supplies, and the like. Where refrigeration is required to preserve the goods the refrigeration may be provided in or to the merchandise container (referred to herein as a “vault”) in a conventional manner.

At block 304 the customer specifies a precise location to which a vault containing the package with the customer merchandise is to be delivered. This can be done by entering Latitude and Longitude information or similar geographical coordinates, or it can be done with a drop-down menu where the precise location at the second site has been previously determined and entered into the computer system. It may also be done by indicating on an interactive map associated with the computer system the precise location for delivery.

At block 306 the data (customer order information from block 302 and customer delivery location information from block 304) is transmitted to a vendor and/or shipper and/or fulfillment company (collectively referred to sometimes herein as “vendor”) so that shipment of the ordered merchandise may be accomplished.

At block 308 the vendor loads one or more packages containing merchandise to be delivered to the customer into a package vault. The merchandise need not be individually packaged.

At block 310 the vault and the packages are scanned or otherwise associated with one another so that the computer system may track the vault and its corresponding packages together.

At block 312 the vault is loaded onto an autonomous delivery vehicle if the vault is not already on the autonomous delivery vehicle at the time of package loading (308).

At block 314 the vault may optionally be aligned so that the vault door is not outwardly exposed (e.g., the vault door is positioned to face the interior of the vehicle for added security). In other embodiments this may not be performed. In some embodiments access to the vault is provided via a door in one side of the vault. For certain customer sites the radial orientation of the door after delivery of the vault may be important (e.g., to avoid having the door face a wall or a planting area). Prealignment of the door at loading or alignment of the door at drop off may be used to alleviate that issue.

At block 316 the vendor uploads delivery location information to the autonomous driving vehicle. This may be in the form of a detailed predetermined route map. Alternatively, it may be in the form of a list of locations and the autonomous delivery vehicle will determine an efficient routing for delivery/pickup of one or more vaults.

At block 318 the autonomous driving vehicle departs the vendor site (also sometimes referred to herein as the “first site”) with the vault containing the package(s) containing the ordered merchandise on board.

At block 320 the autonomous driving vehicle arrives at the customer site (also referred to herein as the “second site”) and positions itself and stops near the “precise location” at which it is to deposit the vault.

At block 322 a robotic arm associated with and mounted on the autonomous driving vehicle is deployed and used to pick up the vault to be delivered to the precise location at the second site. In some embodiments the arm may be mounted within the autonomous driving vehicle and extended outside thereof for the delivery. The arm may be hydraulically powered.

At block 324, using, for example, a GPS receiver or similar accurate positioning device, the robotic arm deposits the vault at the precise location at the second site. The “precise location” may ideally be a flat place, i.e., a sidewalk, in a parking lot or near a loading dock or even on a loading dock. It may optionally be equipped with a locking mechanism such as a post or plate to which the vault may be engaged or locked after having been deposited by the robotic arm.

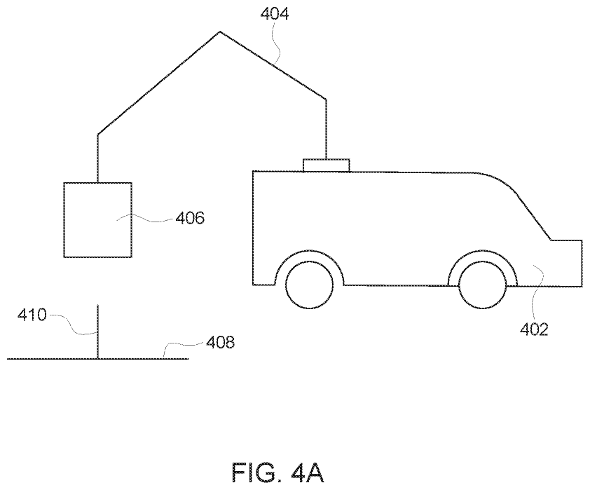

For example, turning to FIGS. 4A and 4B, an autonomous delivery vehicle 402 with a robotic arm 404 is shown delivering a vault 406 to a “precise location” at a second site 408. In FIG. 4A the vault sits on and covers a pin 410 mounted to the ground (such as a concrete pad) and the pin may be engaged by a locking mechanism within vault 406. For example, there may be an aperture in the pin and a solenoid may engage the aperture to help prevent removal of the vault by unauthorized persons. In FIG. 4B a similar arrangement is shown where a pin or plate 412 is mounted to the ground (such as a concrete pad) and the vault may sit next to the pin or plate 412 and engage the pin or plate 412 in a number of conventional ways (e.g., locking solenoid, electro-magnet, and the like).

At block 326, having delivered the vault to the second site, the robotic arm 404 retracts and stows on the autonomous delivery vehicle 402, the autonomous delivery vehicle secures itself for travel, and it departs to its next delivery or back to the first site or to a servicing or storage site.

At block 328 the autonomous delivery vehicle or the vault notifies a central monitoring station using some sort of wireless communications method such as the cellular telephone network or the like that the vault has been delivered to the second site, the central monitoring station in turn notifies the computer system, and the computer system in turn notifies the customer by some sort of electronic communication such as text, e-mail or automated telephone call that a vault with a package has been delivered. Opening the vault will normally require entry of an access code. The access code may be fixed or may change with the delivery. If fixed, then the customer will already know it. If variable, the message to the customer may include the access code or data which may be decrypted to reveal the access code so that the customer may gain access to the vault. Alternatively, the vault may communicate with a customer's smart phone or other device via NFC or some other conventional means.

At block 330 the customer approaches the vault and lets the vault know that he is there. This may be accomplished with a proximity sensor, NFC contact with the customer's smart phone or other device, the customer activating a “wake-up” button or tapping on a touch screen of the vault's user interface, or the like.

At block 332 the vault access interface (electronic access control to allow a recipient to open the vault to retrieve packages) awakens in response to detecting the presence or touch of a potential recipient.

At block 334, operating much like a gas station pump—one enters an access code or possibly an access credential of some kind like an RFID card or mag stripe card or NFC transmitter as from a cellular telephone or the like (optionally together with some sort of Personal Identification Number or PIN code).

At block 336, in response to a successful provision of identifying information to the Vault access interface the vault unlocks and the recipient is able to retrieve the package(s) within. The vault electronics may be pre-loaded with information corresponding to an acceptable access code, or, alternatively, it may wirelessly communicate with the central monitoring station, and via that with the computer system, to determine if the entered access information is acceptable to permit unlocking of the vault. If an acceptable access code is entered by the recipient via the user interface then the vault door will open or unlock allowing the recipient to remove the contents.

At block 338 the recipient retrieves the contents of the vault.

At block 340 the vault electronics detects that the contents have been removed and closes and relocks the vault door.

At block 342 the vault prepares for removal by contacting the central monitoring station and sending a message that delivery is complete. It then shuts down the interface electronics.

At block 344 the computer system arranges to pick up the vault with an autonomous driving vehicle.

At block 346 an autonomous driving vehicle arrives to collect the now empty vault by travelling to the second site, deactivating any ground mounted locking mechanisms, extending the robotic arm to the precise location, and picking up the vault and stowing it on board the autonomous driving vehicle. The robotic arm 404 is then retracted and stowed on the autonomous delivery vehicle 402, the autonomous delivery vehicle secures itself for travel, and it departs for its next delivery/pickup or back to the first site or to a servicing or storage site.

At block 348, if detectors (such as a tilt sensor and/or location detector) on board the vault detect movement of the vault without having received an acceptable access code then at block 350 the vault may optionally sound an alarm signal such as a voice alert or alarm tone or other audible warning signal in an attempt to dissuade theft of the vault and then at block 352 the vault may place a call to the vendor via the central monitoring station in order that the police or other authorities or personnel may be notified as to the presumed attempted theft of the vault.

Additionally, an automated theft/location reporting device may be incorporated into the vault as is often done with higher priced automobiles. The device may be remotely activated in response to the apparent theft of the vault.

Additionally, one or more cameras (still and/or video) may be incorporated into the vault to capture evidence of package delivery, tampering, theft, vandalism and the like and the images uploaded via the cellular communications link to the central monitoring station for future use as required.

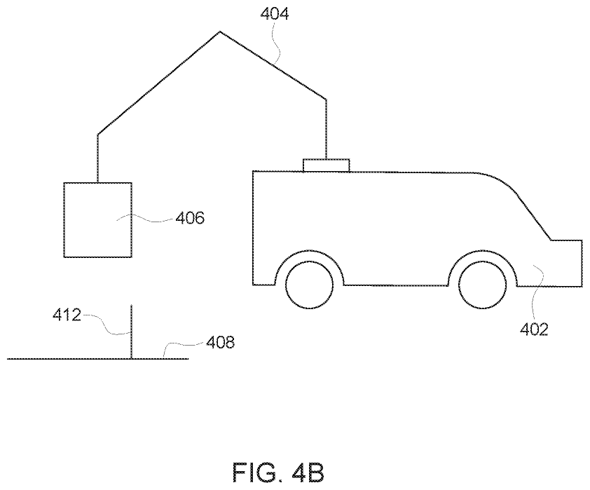

FIG. 5 is a system block diagram of a vault electronics package 500 in accordance with an embodiment. Vault electronics 502 may include a conventional microprocessor and memory storage and interfaces for sensors and interface devices. It may be implemented with any of a number of miniature computers such as miniature personal computers and other small computing devices and/or microcomputers as are well known in the art. It includes a cellular telephone communications device 504 (or other similar radio) and a corresponding antenna 506 to carry out the communications described above. It includes a location sensor 508 such as an on-board Global Positioning System (GPS) unit and corresponding GPS antenna 510 to provide signal to the GPS unit. It may include a tilt or shock sensor 512 so that it knows if it is being upset, shaken or otherwise physically tampered with. It includes a door unlocker mechanism and drive electronics 514 to unlock a door to the vault upon determining that an acceptable access code has been entered. It may include a pin unlocker mechanism and drive electronics to attach and detach the vault to an existing ground-mounted anchoring device. It includes a user interface 518 which may include a touch screen for user interaction and receipt of an access code from a potential recipient. The user interface may include near field communications (NFC) electronics for communicating with a potential recipient's NFC device. It may include one or more conventional presence or proximity sensors 520 to determine if it is being approached or if a potential recipient is nearby or has touched the user interface. Alternatively, it may include some form of “wake-up” button or other mechanism as described above. It may include a solar array 522 to charge a battery 524 which powers the vault electronics. It may include internal lighting 526 activated upon opening the vault door to assist a customer with package retrieval. It may include cameras 528 as described above. It may also include a weight sensor or sensors 530 to determine if its contents are still present or have been received by a customer. It may include a motor (not shown) to automatically open and close the door.

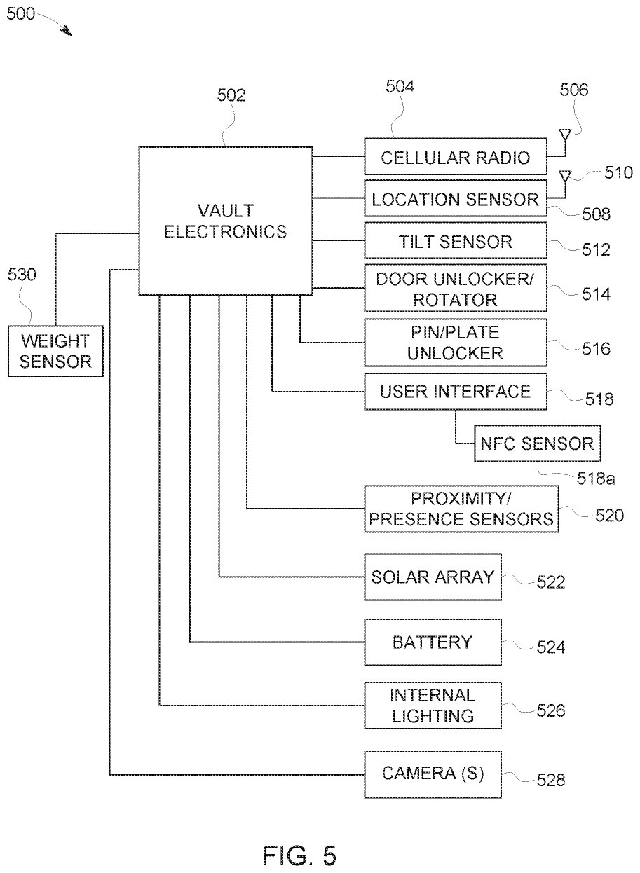

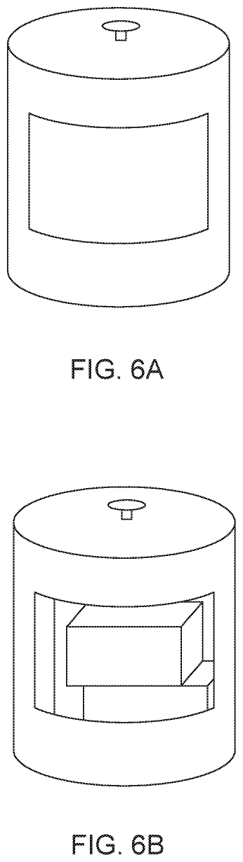

FIG. 6A is a schematic diagram of an implementation of the package vault in accordance with an embodiment. In this embodiment the vault is cylindrical, water proof, fabricated of a tamper resistant material such as steel, some other metal or a composite/plastic material capable of withstanding expected vandalism. A door which rotates out of the way is provided and powered by motors. A solar array 522 may be provided to keep the internal battery 524 charged.

FIG. 6B is a schematic diagram of the implementation of FIG. 6A with the access door shown in the “open” configuration.

As an additional security feature, the base of the vault may be weighted with cement or concrete, metal, sand or the like to make it resistant to tip-over vandalism and more difficult to steal. The vault may be fabricated of materials suitable for the secure storage of the merchandise stored therein such as steel plate or a strong plastic/composite material resistant to vandalism.

While exemplary embodiments and applications have been shown and described, it would be apparent to those skilled in the art having the benefit of this disclosure that numerous modifications, variations and adaptations not specifically mentioned above may be made to the various exemplary embodiments described herein without departing from the scope of the invention which is defined by the appended claims.

What is claimed is:

1. A method for delivering a package from a first site to a second site, the method comprising:
predetermining a precise location at the second site to which the package is to be delivered;
placing the package to be delivered into a vault, the vault being equipped with an audible tamper alarm and a wireless communication system to advise a central monitoring station of tampering and/or package acceptance;
placing the vault onto an autonomous driving vehicle;
causing the autonomous driving vehicle to drive the package to be delivered from the first site to the second site;
delivering the vault to the precise location at the second site using a robotic movement device mounted to the autonomous driving vehicle to transfer the vault from the autonomous driving vehicle to the precise location at the second site;
causing the autonomous driving vehicle to depart the second site after transfer of the vault to the precise location at the second site; and
in response to reported acceptance of the package, causing an autonomous driving vehicle to return to the second site and to retrieve the vault.

2. The method of claim 1 wherein:
the precise location is equipped with a receiver device to which the vault may be locked; and
the vault is locked to the receiver device during the delivering step.

3. The method of claim 1, further comprising:
providing an anti-tipping weight at the bottom of the vault to resist tip-over vandalism.

4. The method of claim 3, wherein:
the anti-tipping weight comprises sand.

4. The method of claim 3, wherein:
the anti-tipping weight comprises metal.

5. The method of claim 3, wherein:
the anti-tipping weight comprises cement and/or concrete.

6. A system for delivering a package from a first site to a second site, the system comprising:
a computer system configured to receive a precise location at the second site to which a vault containing the package is to be delivered;
the computer system configured to identify the package to be placed into the vault;
equipment for automatically placing the package to be delivered into the vault;
the vault equipped with an audible tamper alarm and a wireless communication system to advise a central monitoring station of tampering and/or package acceptance;
equipment for placing the vault onto an autonomous driving vehicle;
the computer system configured to cause the autonomous driving vehicle to drive the package to be delivered from the first site to the second site;
the autonomous driving vehicle equipped with a robotic movement device mounted to the autonomous delivery vehicle for transferring the vault to the precise location at the second site;
the computer system configured to cause the autonomous driving vehicle to depart the second site after transfer of the vault to the precise location at the second site; and
the computer system configured to cause an autonomous driving vehicle to return to the second site to retrieve the vault in response to reported acceptance of the package.

7. The system of claim 6 wherein:
the precise location is equipped with a receiver device to which the vault may be locked; and
the vault is locked to the receiver device during the delivering step.

8. The method of claim 6, further comprising:
providing an anti-tipping weight at the bottom of the vault to resist tip-over vandalism.

9. The method of claim 8, wherein:
the anti-tipping weight comprises sand.

10. The method of claim 8, wherein:
the anti-tipping weight comprises metal.

11. The method of claim 8, wherein:
the anti-tipping weight comprises cement and/or concrete.
